(19) United States
(12) Patent Application Publication
(10) Pub. No.: US 2007/0179885 A1
(43) Pub. Date: Aug. 2, 2007

(54) METHOD AND SYSTEM FOR AUTHORIZING A FUNDS TRANSFER OR PAYMENT USING A PHONE NUMBER

(75) Inventors: Terrence Patrick Bird, Etobicoke (CA); Biswajit Nayak, Etobicoke (CA); Siraj Berhan, Toronto (CA)

Correspondence Address: OGILVY RENAULT LLP, 1981 MCGILL COLLEGE AVENUE, SUITE 1600, MONTREAL, QC, H3A2Y3, US

(73) Assignee: CPNI Inc., Toronto, ON (CA)

(21) Appl. No.: 11/668,665

(22) Filed: Jan. 30, 2007

Related U.S. Application Data
(60) Provisional application No. 60/762,881, filed on Jan. 30, 2006.
(60) Provisional application No. 60/762,882, filed on Jan. 30, 2006.
(60) Provisional application No. 60/762,883, filed on Jan. 30, 2006.

(51) Int. Cl. G06Q 40/00

(52) U.S. Cl. 705/39

(57) ABSTRACT

A system and method for phone authorized transfers and/or payments are described. The system generates and authorizes instructions for funds transfers and payments between sender and recipient of participating institutions. The participating institutions of the sender and recipient of the funds transfer/payment may be the same or different, and may be located within the same or different countries. The system and method generates and authorizes funds transfer/payment instructions using the phone number of the recipient as identifying information and without providing banking particulars of the recipient. In some embodiments, the system implements an interactive voice response (IVR) application allowing a user to interact with the system using voice prompts responsive to the user's spoken response in the telephone receiver or the user input on the keypad of the user's touch-tone wired or wireless telephone. In some embodiments, the phone number of either or both of the sender and recipient may be shared among multiple users.

### RELATED APPLICATIONS

This application claims the benefit of U.S. Provisional Application Nos. 60/762,881, 60/762,882, and 60/762,883, all of which were filed on Jan. 30, 2006.

### TECHNICAL FIELD

This application relates to transactions systems, and more specifically to a system and method for authorizing a funds transfer or payment using a phone number.

### BACKGROUND

User-initiated money and funds transfer and/or payment solutions allow a banking customer to transfer funds between registered accounts of the user or other recipients. Typically, these solutions require the user to register one or more source accounts and each of the recipient or destination bank accounts. As a result, recipients are typically required to provide bank account particulars to the source or sending user for registration purposes. This is inconvenient and requires the recipient to disclose sensitive information to the sender. Further, available solutions may be limited to banking customers within the same financial institution and/or the same country, complicating or frustrating inter-institutional and/or international transactions.

In addition, although such solutions are more convenient when compared with the alternative of attending a bank in person, these solutions are typically provided via the Internet, requiring the banking customer to have access to a computer with access to the Internet. Access to such a computer may not be available or preferable in some instances, for example when travelling or when the banking customer does not have access to what is believed to be a secure computer. Also, Internet-based solutions typically require the user to navigate through a series of windows and menus on one or more web pages to access and complete the funds transfer transaction, which may be difficult and inconvenient for some banking customers. Further, Internet-based solutions may incorporate a relatively complex transaction workflow which may provide yet further difficulties and inconvenience for some banking customers.

Accordingly, there exists a need for an improved method and system for authorizing a funds transfer and/or payment.

### SUMMARY

A system and method for phone authorized transfers and/or payments are described. The system generates and authorizes instructions for funds transfers and payments between a sender and recipient of participating institutions. The participating institutions of the sender and recipient of the funds transfer/payment may be the same or different, and may be located within the same or different countries. The system and method generate and authorize funds transfer/payment instructions using the phone number of the recipient as identifying information and without providing banking particulars of the recipient. In some embodiments, the system implements an interactive voice response (IVR) application allowing a user to interact with the system using voice prompts responsive to the user's spoken response in the telephone receiver or the user input on the keypad of the user's touch-tone wired or wireless telephone. In some embodiments, the phone number of either or both of the sender and recipient may be shared among multiple users.

In accordance with one embodiment of the present application, there is provided a phone authorized transfer and/or payment system for generating funds transfer instructions between a sender and a recipient. Each of the sender and recipient have a phone number registered with the system and stored within a respective customer database. The system comprises a first telephone application gateway server comprising a processor operatively connected to a memory, the memory having data and instructions stored thereon to configure the first telephone application gateway server to implement an interactive voice response (IVR) application for interfacing with a sender and to: request and receive a funds transfer request from the sender via a call received by the IVR application, the funds transfer request comprising at least an amount for transfer (the “transaction amount”) and a phone number of the recipient; determine the sender's phone number; verify the determined sender's phone number against registered phone numbers in a first customer database connected to the first telephone application gateway server; and if the determined sender's phone number is verified, determine a first proxy identifier (ID) associated with at least the determined sender's phone number from the first customer database; and send to a first transaction instruction server managed by a first participating institution a first funds transfer request to transfer funds from an account of the sender at the first participating institution to an outgoing settlement account of the first participating institution, wherein the first funds transfer request includes the first proxy ID as a pointer to the account of the sender from which the funds are to be transferred, the first funds transfer request instructing the first transaction instruction server to generate a first funds transfer instruction.

In accordance with another embodiment of the present application, there is provided a method for generating funds transfer instructions between a sender and a recipient in a phone authorized transfer and/or payment system. Each of the sender and recipient have a phone number registered with the system and stored within a respective customer database. The method comprises the steps of: receiving an identifier from a sender; receiving from the sender a funds transfer request on a first server, the funds transfer request comprising at least an amount for transfer (the “transaction amount”) and a phone number as identifying information of a recipient to which the funds are to be transferred; determining a first proxy identifier (ID) associated with the identifier of the sender; sending to a first transaction instruction server instructions to generate funds transfer instructions associated with the first proxy ID; and generating first funds transfer instructions on the first transaction instruction server, the first funds transfer instructions including the first proxy ID as a pointer to an account of the sender at a first participating institution from which the funds are to be transferred.

In accordance with a further embodiment of the present application, there is provided a system for generating funds transfer instructions between a sender and a recipient. Each of the sender and recipient have a phone number registered with the system and stored within a respective customer database. The system comprises: a first server having a processor operatively connected to a memory, the memory having data and instructions to configure the server to: receive an identifier from a sender; receive from the sender a funds transfer request, the funds transfer request comprising at least an amount for transfer (the “transaction amount”) and a phone number as identifying information of a recipient to which the funds are to be transferred; determine a first proxy identifier (ID) associated with the identifier of the sender; and send to a first transaction instruction server instructions to generate funds transfer instructions associated with the first proxy ID; wherein the first transaction instruction server generates first funds transfer instructions, the first funds transfer instructions including the first proxy ID as a pointer to an account of the sender at a first participating institution from which the funds are to be transferred.

In accordance with yet a further embodiment of the present application, there is provided a method for registering a user in a phone authorized transfer and/or payment system. The method comprises the steps of: receiving a request to register the user on a telephone gateway application server for managing the user's funds transfer communications, the request including a phone number of the user and a proxy identifier (ID) to an account of the user at a first participating institution from which funds are to be transferred; generating a unique user identifier (ID) being unique at least within a customer database connected to the telephone gateway application server; storing a mapping of a phone number of the user to the unique user ID to the proxy ID in the customer database; and receiving an activation request from the user.

In accordance with yet a further embodiment of the present application, there is provided a system for registering a user having a shared phone number in a phone authorized transfer system. The system comprises a telephone gateway application server for managing the user's funds transfer communications, the telephone gateway application server being operatively connected to a customer database, the telephone gateway application comprising a processor operatively connected to a memory, the memory having data and instructions stored thereon to configure the telephone gateway application server to: receive a request to register the user, the request including a phone number of the user and a proxy identifier (ID) to an account of the sender at the first participating institution from which funds are to be transferred; generate a unique user identifier (ID) being unique at least within a customer database connected to the telephone gateway application server; store a mapping of a phone number of the user to the unique user ID to the proxy ID in the customer database; and receive an activation request from the user.

In accordance with yet further embodiments of the present application, there is a system and apparatus adapted for practising the method of the application, articles of manufacture such as a machine or computer readable medium having program instructions recorded thereon for practising the method of the application, as well as a computer data signal having program instructions recorded therein for practising the method of the application.

These and other aspects and features of the application will become apparent to persons of ordinary skill in the art upon review of the following detailed description, taken in combination with the appended drawings.

### BRIEF DESCRIPTION OF THE DRAWINGS

FIG. 1 is a schematic diagram illustrating a system for generating and acquiring instructions for a funds transfer in accordance with one embodiment of the present application;

FIG. 2A is a flowchart illustrating operations for sending funds transfer instructions to a source PayLink™ server from a service control host server in accordance with one embodiment of the present application;

FIG. 2B is a flowchart illustrating operations for sending funds transfer instructions to a destination PayLink™ server from a service control host server in accordance with one embodiment of the present application;

FIG. 3 is a flowchart illustrating operations for registering a user from a participating bank and activating a user account in accordance with one embodiment of the present application;

FIG. 4 is a flowchart illustrating exemplary operations for generating instructions for a funds transfer from the perspective of a user of the system of FIG. 1 in accordance with one embodiment of the application;

FIG. 5 is a schematic diagram illustrating a system for generating and acquiring instructions for a funds transfer in accordance with another embodiment of the present application;

FIG. 6 is a flowchart illustrating operations for registering and activating a user account on a shared phone number in accordance with another embodiment of the present application; and

FIG. 7 is a flowchart illustrating operations for identifying recipients on a shared phone number in accordance with another embodiment of the present application.

It will be noted that throughout the appended drawings, like features are identified by like reference numerals.

### DETAILED DESCRIPTION OF THE PREFERRED EMBODIMENTS

The following detailed description of the embodiments of the present application does not limit the implementation of the application to any particular computer programming language. The present application may be implemented in any computer programming language provided that the operating system (OS) provides the facilities that may support the requirements of the present application. An embodiment is implemented in the Java™ computer programming language (or other computer programming languages such as C or C++) (Java and all Java-based trade-marks are the trade-marks of Sun Microsystems Corporation). Any limitations presented would be a result of a particular type of operating system or computer programming language and would not be a limitation of the present application.

The present application describes a phone authorized transfer and/or payment method and system for generating and acquiring instructions for funds (money) transfers between a first customer of a first participating institution and a second customer of a second participating institution. The first and second participating institutions may be the same or different, and may be located within the same or different countries. The first and second participating institutions are typically but not necessarily financial institutions such as banks. The participating institutions may also be a point of transfer entity or institution (e.g. Western Union or the like), a trust company or other participating entity or institution. The method and system generates and acquires instructions for a funds transfer using only the phone number of the recipient as identifying information. The phone number of either or both of the sender and recipient may be shared among multiple users.

### System Architecture

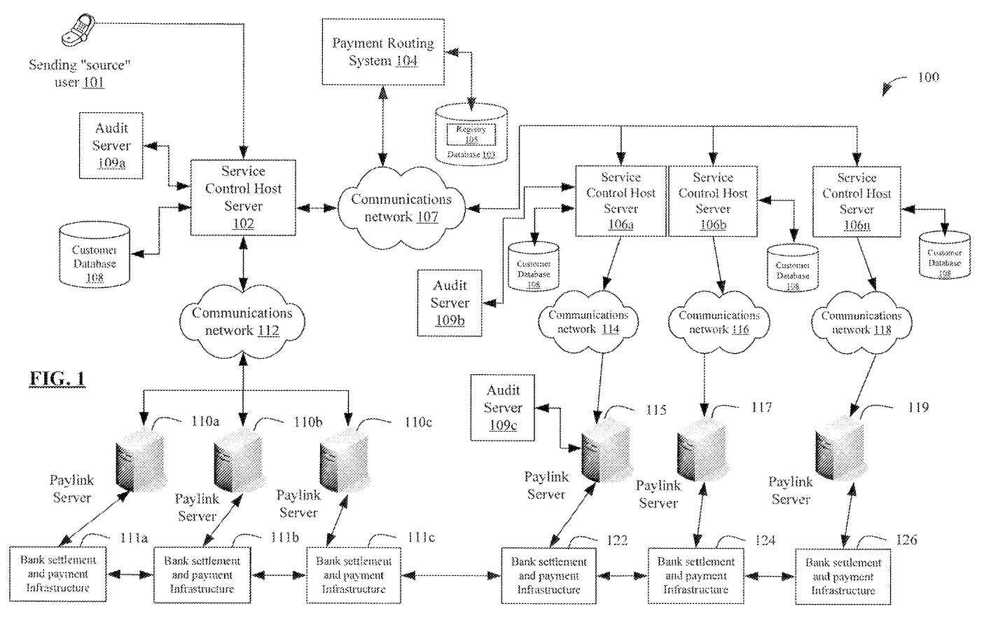

FIG. 1 is a schematic diagram illustrating a system 100 for generating and acquiring instructions for a funds transfer in accordance with one embodiment of the present application. The system 100 comprises a “source” telephone application gateway (“service control host”) server 102 for managing the funds transfer communications of a source or sending user 101, and a plurality of service control host (SCH) servers 106 for managing the funds transfer communications of other users, represented individually by references 106a, 106b . . . . 106n, and a payment routing system (PRS) 104 interconnected by a communications network 107. The payment routing system 104 provides location information (e.g. address mappings) to the service control host servers 102, 106 so that they can locate each other.

The service control host servers 102, 106 provide a telephone gateway application server for managing (i.e. receiving, processing, sending, etc,) the respective funds transfer communications (i.e. user fund transfer requests, and fund transfer instructions) of the sender and recipient. Each service control host server 102, 106 provides a voice or telephone-accessible application gateway for a respective telecommunications network covering a given region, such as a country or group of countries with a shared telecommunications network, in the system 100. Typically, each service control host server 102, 106 manages a voice or telephone gateway within one country, however the service control host servers 102, 106 may manage a telephone application gateway for multiple countries or regions. The telecommunications providers within each region provide the phone number of an incoming caller, however the service control host servers 102, 106 do not typically interface with the telecommunications (e.g. telephony) service implementation of the respective telecommunications providers. The present application is not limited by the telecommunications providers.

The service control host servers 102, 106 receive and process incoming user telephone calls to the system 100. The service control host servers 102, 106 implement a telephone or voice gateway (e.g., an interactive voice response system) that performs at least the following functions: (1) provide an interactive voice response (IVR) application to respond to a sender's request to transfer funds using a wired (landline) or wireless (mobile) telephone or communications device; (2) receive and process registration requests from transaction instruction servers or “PayLink™ servers 110 and store user information (including phone number and PayLink™ account ID) in association with a unique user identifier (ID); (3) query or look-up location (address) information of destination service control host servers; and (4) communicate with other service control host servers 102, 106.

Each service control host server 102, 106 is connected to a respective customer database 108 and voice gateway or voice gateway routers (not shown) preferably capable of interfacing with both analog and digital telephony networks. The voice gateways also implement the IVR application for receiving and processing incoming calls, etc. IVR allows a user to interact with the system 100 using voice prompts responsive to the user's spoken response in the telephone receiver or the user input on the keypad of the user's touch-tone wired or wireless telephone. The voice gateways communicate with a customer interface and authentication subsystem (not shown) which provides business logic, audio, and VoiceXML (VXML) for implementing the IVR application. The source service control host server 102 routes transactions from the user's “source” bank to the participating recipient's “destination” bank. The service control host servers 102, 106 also interact with the payment routing system 104 to determine the correct destination service control host server with which to communicate. A message response technology other than IVR may also be used in some embodiments.

The service control host servers 102, 106 may additionally comprise a services server for providing service and/or a World Wide Web (WWW or Web) administration server for providing a Web interface for the administration of the service control host servers 102, 106. The IVR application, the customer database 108, the services server, and the Web administration server aspects of the service control host servers 102, 106 may be implemented as software modules running on the service control host servers 102, 106, or as a plurality of interconnected servers each running one or more of the software modules responsible for implementing these services.

In one embodiment, the service control host servers 102, 106 provide the primary means of interaction with the end-user by providing an easy-to-use IVR application to guide customers through the funds transfer process. Each service control host server 102, 106 contains a set of voice-gateway routers capable of interfacing with both analog and digital telephony networks. The voice-gateway routers communicate with the service control host servers 102, 106, which provide business logic, audio, and VXML for interpretation. The service control host servers 102, 106 in turn interact with the payment routing system 104 to determine the correct destination for international and domestic funds transfer. The functional services provided by the various modules of the service control host servers 102, 106 include the IVR application, user authentication, an Application Programming Interface (API) for Service fee computation for SCH, and an email or SMS notification interface.

In one embodiment, the IVR application provides for: (a) fund transfer call flow; (b) account management by users; and (c) activation of account by users. When the user calls a specific phone number, the IVR application provides for funds transfer call flow by interacting with the caller using the language of the user's choice and by taking the user through a defined process of collecting information for the funds transfer. The user can use the account management feature of the IVR application to manage his accounts for activities such as changing passwords, setting of preferred accounts for deposit and withdrawal, etc. When the user is first registered, the system sends a notification to the user. The user then calls using the registered telephone to activate the account.

The user authentication module of the service control host servers 102, 106 checks the authenticity of the user based on the incoming caller's phone number and personal identification number (PIN) or password. The user authentication module also implements security measures such as, for example, locking the phone number in case of repeated unsuccessful login attempts.

The API for service fee computations for SCH and PayLink™ is an interface between the sending source user 101 and both the SCH server 102 and the PayLink™ server 110 to provide the service fee for standard, as well as immediacy transactions. The fees are computed by the SCH and PayLink™ for each transaction and the resultant fees are communicated to the user using this interface.

The email or SMS notification interface module makes use of the existing email/SMS services and initiates event based messages using these services.

The Web administration server module is a web application used by users (e.g., administrators) to query and view the past transactions and also provides the following functions: (a) adding a new financial institution; the ability to add a new financial institution to the system 100 includes the process of adding or removing a node and/or host, which may be done in concert with other administrators; and (b) changing territory partner configuration; which involves changing the configuration for components related to the territory partner.

An audit server (e.g., 109a) for the service control hosts servers 102, 106 (described in more detail below) is, in one embodiment, an independent module outside of the service control host server 102 that logs the transaction data relevant to the corresponding service control host. Typically, no sensitive information such as bank account numbers or passwords is logged. Typically, each component has an audit server that logs transactions data related to its own functions.

The payment routing system 104 informs the source service control host server 102 which destination service control host server (e.g. 106a) to communicate with based upon the destination phone number. If the sender (source) and recipient (destination) are registered on the same service control host server, the destination service control host server may be the source service control host server 102 itself. The payment routing system 104 is a tool for determining the corresponding service control host server from a registered phone number. In some embodiments, the payment routing system 104 includes a database 103 comprising an account table or registry 105 comprising a phone number to service control host server address mapping for routing communications between the respective service control host servers 102, 106. Typically, the registry comprises a mapping of the phone number to the respective service control host server address for each registered user having an active user account. The payment routing system 104 may comprise one or more switches for connecting the source service control host server 102 with the destination service control host server (e.g., 106a).

The payment routing system 104 is responsible for routing domestic and cross-border transactions between participating banks. One component of the payment routing system 104 is a phone number to country code and service control host server address mapping module that ensures funds are sent to the correct recipients in the end. In one embodiment, the payment routing system 104 is maintained by a service provider and is designed with compliance to international privacy and security standards, open architecture standards, platform flexibility and scalability, physical and logical security standards and universally adopted norms. The payment routing system 104 allows different network nodes to locate each other in a discriminating manner.

Each registered user is registered in association with a phone number handled or managed by a respective service control host server 102, 106. Each phone number is managed by only one service control host server 102, 106. Each registered user is associated with a unique user ID that is at least unique within the service control host customer database 108.

Each customer database 108 comprises data for the respective service control host customers registered with the system 100, including customer identification information, a phone number registered with the system 100, the unique user ID, and bank proxy interface information (referred to as a “PayLink™ account identifier (ID)”). The customer database 108 does not include any banking information about the service control host customers. Within the customer database 108, the registered phone number and PayLink™ account ID are mapped to the corresponding unique user ID. The PayLink™ account ID is mapped to a PayLink™ server address so that the responsible PayLink™ server 110 may be identified. As described more fully below, multiple bank accounts and/or multiple phone numbers may be registered with the system in association with a given unique user ID.
phone number <--(n)--------(n)-->unique user ID<--(1)--------(n)-->PayLink™ account ID<--(n)------(1)->PayLink™ server address
   where n is an integer≧1.

n phone numbers registered with the system can map to n unique user IDs. For each unique user ID, there may be n PayLink™ account IDs (where each PayLink™ account ID corresponds to a bank account registered with the system). Each of the n PayLink™ account IDs are mapped to a PayLink™ server address, however the individual single PayLink™ server addresses may be different between PayLink™ account IDs. It will be appreciated that using the mapping, the PayLink™ account ID may be determined using the unique user ID and the unique user ID may be determined via the registered phone number. In cases where phone numbers are not shared and the user registers only one phone number and one account, this is analogous to a mapping directly from a registered phone number to a PayLink™ account ID. Access to the customer database 108 is securely managed by a customer interface and authentication subsystem (not shown).

The source service control host server 102 is connected to a plurality of PayLink™ servers 110, represented individually by references 110a, 110b and 110c, managed or operated by respective participating entities or institutions (e.g. banks) by a communications network 112. The service control host servers 106 are connected to a plurality of PayLink™ servers 115, 117 and 119 managed or operated by respective participating entities or institutions by respective communications networks 114, 116 and 118. For purposes of simplicity, only one PayLink™ server has been shown for each of the service control host servers 106. It will be appreciated by persons ordinarily skilled in the art that there may be more than one participating institution (and corresponding PayLink™ servers) connected to the service control host servers 106. Additionally, each of the servers 102, 106, 110, 115, 117, and 119 may either be connected to an additional audit server 109 or may run an audit server module. The audit servers 109 may be recording and reporting servers or modules responsible for aiding in maintaining the integrity of the system 100. While only audit servers 109a, 109b and 109c are shown connected to the service control host servers 102 and 106a and the PayLink™ server 115, all of the service control host servers 102, 106 and the PayLink™ servers 110, 115, 117, and 119 would typically have a connected audit server.

The PayLink™ servers 110 are also connected to the respective banks' settlement and payment infrastructure 111, represented individually by references 111a, 111b and 111c. Similarly, the PayLink™ servers 115, 117 and 119 are connected to the respective banks' settlement and payment infrastructure 122, 124, and 126. The respective bank settlement and payment infrastructures 111, 122, 124 and 126 are interconnected for carrying out domestic and international fund transfer transactions, such as by Swift or similar transfer channels. The PayLink™ servers 110, 115, 117 and 119 provide a standardized communications protocol for communicating with the system 100 and securely connecting to the respective bank's internal communications network and infrastructure, thereby providing a first line of security by introducing a degree of separation between the bank's network and remainder of the system 100. For purposes of simplicity, the exemplary participating entities and institutions are sometimes described as banks, however persons ordinarily skilled in the art will appreciate that participating entities and institutions are not limited to banks.

Each PayLink™ server 110, 115, 117 and 119 is connected to a PayLink™ customer database (not shown) comprising customer registration data specific to the respective bank. Each PayLink™ customer database comprises data for each registered banking customer of the respective bank, including customer identification information, bank account information (such as account type, account number, and currency), and bank proxy interface (PayLink™) account information. Within each PayLink™ customer database, the bank account number is mapped to a PayLink™ account ID which is mapped to a registered user. Typically, a PayLink™ account ID is provided for each registered bank account. A user may have more than one registered bank account and therefore more than one PayLink™ account ID. Additionally, each PayLink™ server 110, 115, 117, and 119 has a Web administration module and a services server connected with the customer database. The customer database, the Web administration module, and the services server are typically software modules running on the PayLink™ servers 110, 115, 117, and 119, but may also be implemented as discrete, interconnected servers. Each PayLink™ server 110, 115, 117, and 119 may also have connected to an audit server 109c as an example (only one audit server 109c is shown, connected to the PayLink™ server 115).

The PayLink™ servers 110, 115, 117, and 119 that provide the PayLink™ services include a number of functional components (e.g., software modules running on the servers) including a customer account management module, a bank interaction module, an inter and intra-bank settlement module, and an API for Service Fee Computation Interface for the service control host servers 102, 106.

The customer account management module adds and modifies accounts and related data in a local database (e.g., a database forming part of the PayLink™ servers 110, 115, 117, and 119). A customer service representative of the financial institution creates the accounts and maintains them using this module. A bank normally does the standard “Know Your Customer” checks before creating such accounts. Customer account information may be propagated to the system 100 through batch or rapid uploads during the bank customization phase, as described more fully below.

The bank interaction module serves to provide for inter account funds transfers, sufficient funds checks, and exchange rate requests. The bank interaction module is an interface with the PayLink™ server via the service control host servers 102, 106 using the PayLink™ account IDs to interact with financial institutions for functions such as querying the financial institution in real time to check if sufficient funds are available for a transaction and receiving the response from the financial institution, requesting an exchange rate, requesting the financial institution to transfer funds between accounts, etc.

The inter-bank and intra-bank settlement module would aggregate the transactions and request wire transfer of a gross amount or a net amount to the destination financial institutions. In case the settlement is between two accounts in the same bank, there would be no actual wire transfer involved.

The API for Service Fee Computation Interface for the service control host servers 102, 106 provides an interface with the banks to provide the service fee for standard and immediacy transactions. The fees are decided by the financial institutions based on the source bank, the transfer amount, and other criteria that the bank considers important to limit its exposure and reduce financial risks.

The Web administration module is a web application accessible to administrators using the Internet and is used to query and view the past transactions and provide other functions, including: (a) changing the specific parameters related to the financial institution's configuration; (b) adding a new service control host server to an existing node, with the nodes being comprised of multiple hosts to allow scalability and robustness; and (c) removing a service control host server from a node, typically for maintenance and upgrade purposes.

The audit server 109c connected to the PayLink™ server 115 may be independent server modules implemented outside of the PayLink™ server 115, that log the transaction data relevant to the PayLink™ server 115. Typically, no sensitive information such as bank account numbers or passwords is logged. The audit server is specific to a component and is not shared.

The communications networks 107, 112, 114, 116 and 118 may be the same or different, and may comprises the Internet (e.g., TCP/IP networking), Wireless Fidelity (Wi-Fi) network, telephony communication, radio communication, a proprietary interface or connection, or other communications network. The configuration and/or capabilities of the communications networks 107, 112, 114, 116 and 118 are not intended as a limitation of the present application.

The system 100 provides account and user management applications for implementing a variety of account and user management functions. User management functions are performed by users and include changing the default or preferred bank account in which to receive funds and changing passwords or personal identification numbers (PINs). Account management functions are performed by the participating financial institutions and include adding and removing registered phone number(s), adding and removing registered bank accounts, and/or adding and removing users on a shared phone number. The account and user management applications are typically provided as part of a larger application that may be a web-based application accessible from a secure computing terminal, an IVR application, a local application accessible from a user's personal computer or the like, or may be implemented by other methods.

To perform a funds transfer, both the sender and recipient must be registered and have active user accounts with the system 100. Users may request registration in the system 100 when setting up or updating their banking services at their respective participating banks. For example, registration may be requested as part of a banking package, for example when a bank account is created or banking profile is changed. The system infrastructure will then register the user, after which the user must then activate the user account as described in more detailed below. Further, each user may register more than one bank account with the system 100 using the same registered phone number.

In some embodiments, as new users are added to the system 100, for example as individuals within a participating institution or new participating institutions are added to the system 100, the phone numbers and PayLink™ account IDs are uploaded from the respective PayLink™ servers to the respective service control host servers 102, 106. The timing of uploads from PayLink™ servers is based on definable criteria, for example upon full implementation of a PayLink™ server, at the end of every business day, after every 250 new accounts, etc. The respective service control host servers 102, 106 then upload the phone number information to the payment routing system 104 so that the phone number to service control host server mapping may be updated. Alternatively, in other embodiments the system 100 receives uploads instantaneously rather batch uploads.

The system 100 provides the following global infrastructure modules: a global telephone number to service control host server 102 address mapping at the payment routing system 104 as mentioned earlier, and an independent hardware and software monitoring system to check and report failures.

### Generation of Funds Transfer Instructions

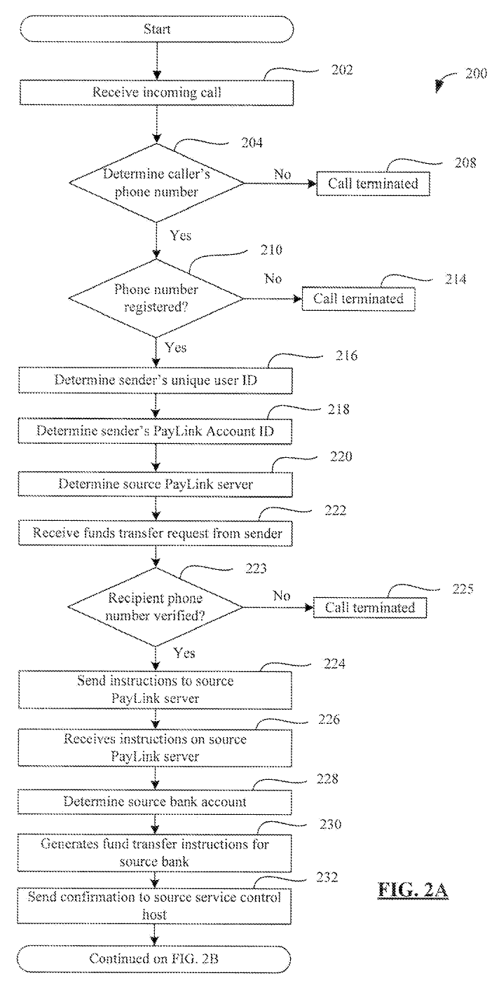

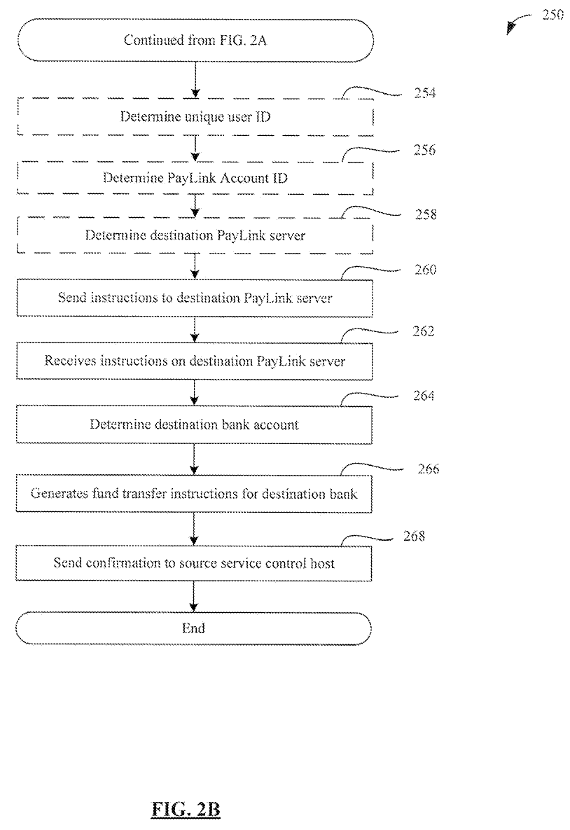

Referring to FIG. 2A, exemplary operations 200 for sending funds transfer instructions to a source PayLink™ server from a source service control host server 102 in accordance with one embodiment of the present application will be described The operations 200 assume the sender and recipient have phone numbers registered with the system 100 and have active users accounts. The registered phone number(s) may be a phone number of a wired or wireless telephone.

In a first step 202, an incoming call from a sender is received by the system 100 at a local or toll-free bank phone authorized transfer (PAT) number. The incoming call is handled by the IVR application of the telephone application gateway server (e.g., the service control host server 102). Next in a step 204, the sender's phone number is determined using suitable caller identification techniques. Suitable caller identification techniques would be understood by a person of ordinary skill in the art and will not be described here. If the sender's phone number is unlisted or blocked, the sender's phone number cannot be determined and the call will end (not shown). Users having an unlisted or blocked phone number will need to have their phone number listed or unblocked to use the system 100 in this configuration. Alternatively, in other embodiments other forms of identification may be used in which case the unlisting or blocking of the sender's phone number may not be problematic.

If the sender's phone number cannot be determined due to caller identification blocking or for other reasons, operations proceed to a step 208 where the call is terminated. Originating phone numbers are difficult to falsify and/or mimic by the laymen and so using the sender's phone number as an identifier provides the system 100 with an additional layer of security by requiring funds transfers to be placed from a registered phone number only. If the sender's phone number has been determined, next in a step 210, the sender's phone number is compared against the customer database 108 to determine if the phone number is a registered phone number of a registered user of the system 100. If the phone number is not a registered phone number of a registered user of the system 100, operations proceed to a step 214 where the call is terminated.

If the phone number is a registered phone number of a registered user of the system 100, operations proceed to steps 216 and then 218 where the service control host server 102 determines a first proxy identifier (proxy ID) associated with the registered phone number. Typically, the step of determining the first proxy ID comprises two steps of determining a unique user ID associated with the registered telephone number (i.e., the step 216) and then determining a corresponding PayLink™ account ID using the unique user ID (i.e., the step 218). As described above, the service control host server 102 is provided with a mapping of the phone number and PayLink™ account ID to the unique user ID for each registered user (e.g., in the customer database 108). Once the unique user ID is determined from the phone number, the corresponding one or more PayLink™ account IDs can be readily determined using this mapping.

Next in a step 220, the source PayLink™ server 110 and the PayLink™ server address are determined based on information stored in the customer database 108, for example using a mapping of PayLink™ account IDs to the PayLink™ server addresses. Alternatively, the PayLink™ server 110 associated with the PayLink™ account ID may be determined using the PayLink™ account ID itself based on information about the respective PayLink™ server 110 encoded with the PayLink™ account ID within the PayLink™ account ID format.

Next in a step 222, a funds transfer request is received from the user via a series of voice prompts provided by the IVR application. The input of the user comprises at least the phone number of the funds transfer recipient. As described above, the sender may provide information to the IVR application via spoken response into the telephone receiver or by inputting the required information via the telephone keypad.

Next, in step 223 the service control host server 102 verifies the recipient's phone number is a registered phone number and is associated with an active user account. The verification typically comprises determining a second proxy ID associated with the recipient's phone number. Typically, the step of determining the second proxy ID comprises two steps of determining a unique user ID associated with the recipient's phone number and then determining a corresponding PayLink™ account ID using the unique user ID of the recipient. As described above, each service control host server 102, 106 is provided with a mapping of the phone number and unique user ID to the PayLink™ account ID for each registered user in the respective customer database 108. Once the unique user ID is determined from the phone number, the PayLink™ account ID can be readily determined using this mapping. Next, the destination PayLink™ server 110 and the PayLink™ server address are determined based on information stored in the customer database 108, for example using a mapping of PayLink™ account IDs to the PayLink™ server addresses. Once the PayLink™ account ID determined, the recipient's phone number has been verified. If the destination PayLink™ account ID cannot be determined, then the recipient's phone number is not verified and the operations proceed to a step 225 where the call is terminated.

If the destination service control host server 106 associated with the recipient's phone number is not the same as the source service control host server 102 then the payment routing system 104 is engaged to identify the destination service control host server 106 associated with the recipient's phone number. The source service control host server 102 then communicates with the destination service control host server 106 to obtain the PayLink™ account ID to verify the recipient's phone number is a registered phone number and obtain the destination PayLink™ server address. The destination service control host server 106 performs the check to verify the recipient's phone number is a registered phone number and inform the source service control host server 102 of the result of the check and the destination PayLink™ server address.

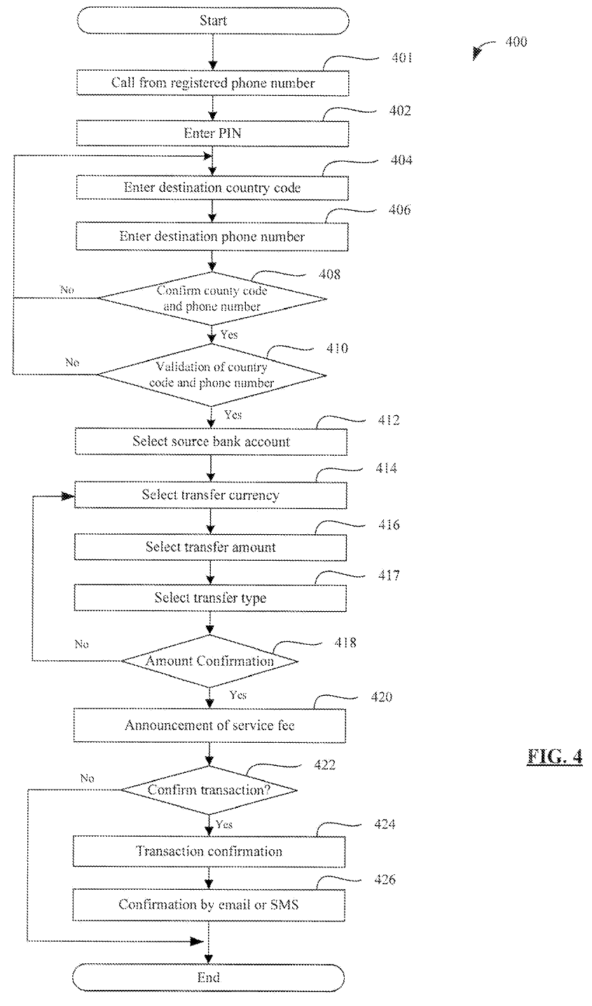

Next in a step 224, the source service control host server 102 generates and sends an electronic funds transfer instruction to the source PayLink™ server 110 in accordance with the funds transfer request received from the sender via the IVR application in the step 222. Exemplary call flow of the IVR application is described below in connection with FIG. 4. The funds transfer instructions instructs the source PayLink™ server to transfer funds from the sender's bank account associated with the PayLink™ account ID to an outgoing settlement account of the sender's bank (i.e., the source bank). No bank account information is transmitted by the source service control host server 102 to the source PayLink™ server 110 since none is known. Only a pointer to the sender's bank account in the form of the PayLink™ account ID is given.

Next, in a next step 226, the electronic funds transfer instruction is received on the source PayLink™ server 110 associated with the sender. Next in a step 228, the source PayLink™ server 110 determines the bank account number of the sender using a bank account number to PayLink™ account ID mapping stored in a customer database (not shown) connected to the PayLink™ server 110. Next in a step 230, the PayLink™ server 110 generates instructions to transfer funds from the determined bank account number of the sender to an outgoing settlement account of the sender's bank referred to as an Outgoing Accumulated Account. The Outgoing Accumulated Account is an account at a source participating bank where outgoing funds are first sent as part of the settlement process. The funds are collected within the Outgoing Accumulated Account before they are sent to an incoming settlement account of the recipient's bank referred to as an Incoming Accumulated Account of the destination bank. The funds are then distributed from the Incoming Accumulated Account to individual recipient accounts as described more fully with reference to FIG. 2B.

Next, in step 232, a confirmation message is sent back to the source service control host server 102 from the PayLink™ server 110 to confirm that the funds transfer instructions have been sent to the source bank.

Referring to FIG. 2B, exemplary operations 250 for sending funds transfer instructions to a destination PayLink™ server 117 associated with the recipient's phone number from the source service control host server 102 in accordance with one embodiment of the present application will be described. Once the instructions have been sent to transfer the funds from the sender's bank account, as described in relation to FIG. 2A, instructions must be sent to transfer the funds to the recipient's bank account, as is described below.

Optionally, the operations 250 commence with steps 254 to 258 if the destination service control host server 106 merely informs the source service control host server 102 of the result of the check to verify the recipient's phone number is a registered phone number and the destination PayLink™ server address, the PayLink™ account ID of the recipient check and the destination PayLink™ server address must be determined. Alternatively, if the PayLink™ account ID was previously obtained in step 223, operations proceed to step 260.

In step 254, the unique user ID associated with the recipient's phone number is determined using the phone number to unique user ID mapping stored in the customer database 108. Next, in step 256 the destination PayLink™ account ID is determined using the unique user ID to PayLink™ account ID mapping stored in the customer database 108. Next, in step 258 the destination PayLink™ server (e.g., 117) is determined based the mapping of PayLink™ account IDs to the PayLink™ server addresses stored in the customer database 108. Alternatively, the PayLink™ server 117 associated with the PayLink™ account ID may be determined using the PayLink™ account ID itself based on information about the respective PayLink™ server 117 encoded with the PayLink™ account ID within the PayLink™ account ID format.

In a step 260, the source PayLink™ host server 110 generates and sends an electronic funds transfer instruction to the destination PayLink™ server 117 via the destination PayLink™ server address determined in step 223 in accordance with the funds transfer request received from the sender via the IVR application in the step 222. The funds transfer instructions instructs the destination PayLink™ server 117 to transfer funds from an incoming settlement account of the recipient's bank (i.e., the destination bank) to the bank account associated with the recipient's PayLink™ account ID determined in step 223. No bank account information is transmitted by the source service control host server 102 to the destination PayLink™ server 117 since none is known. Only a pointer to the recipient bank account in the form of the PayLink™ account ID is given.

Next in a next step 262, the electronic funds transfer instruction is received on the destination PayLink™ server 117 associated with the recipient. Next in a step 264, the destination PayLink™ server 117 determines the bank account number using a bank account number to PayLink™ account ID mapping stored in a customer database (not shown) connected to the destination PayLink™ server 117.

Next in a step 266, the PayLink™ server 117 generates instructions to transfer funds from an incoming settlement account of the recipient's bank (referred to as an Incoming Accumulated Account of the destination bank) to the determined bank account number of the recipient. With the non-immediacy option, the Incoming Accumulated Account is an account at the destination participating bank where incoming funds are sent to from an Outgoing Accumulated Account of the source participating banks as part of the settlement process. The funds are then distributed from the Incoming Accumulated Account to the individual recipient account.

Next, in step 268, a confirmation message is sent back to the source service control host server 102 from the destination PayLink™ server 110 via the destination control host server 106 to confirm that the funds transfer instructions have been sent to the destination bank.

Once the source service control host server 102 has received confirmation from the source PayLink™ server 110 and destination PayLink™ server 117 that the funds transfer instructions have been sent to the source bank (step 232) and the destination bank (step 262), the operations 200 and 250 end.

It will be appreciated that due to security and firewall restrictions, the source server control host server 102 cannot communicate directly with the destination PayLink™ server 117 or vice versa. The source service control host server 102 can only communicate directly with the source PayLink™ server 110 and destination server control host server 106. If the source service control host server 102 needs to communicate with the destination PayLink™ server 117 during this method or any other, or if the destination PayLink™ server 117 needs to communicate with the source service control host server 102, this is done via the destination service control host server 106 acting as an intermediary.

While the processes 200 and 250 are described as being conducted serially or sequentially, it will be understood by those skilled in the art that many aspects of the processes 200 and 250 may be processed concurrently or in parallel. It will also be understood by those skilled in the art that many of the steps shown in the processes 200 and 250 need not necessarily be executed in the shown order, and that variations in the method order may be implemented as would be understood to a person skilled in the art.

### Settlement Process

The actual transfer of funds is handled en masse using the conventional bank settlement and payment infrastructures 111, 122, 124 and 126. Transaction settlement may be automatic upon the occurrence of a predetermined event, at predetermined internals, upon a predetermined number of transactions being completed, or transaction settlement may be manually triggered by an administrator of the system 100.

Transaction may be immediate or non-immediate in nature. For a non-immediate transfer, during the settlement process the funds are transferred from the Outgoing Accumulated Account of the sender's bank to an Incoming Accumulated Account for the system 100 held by the destination bank associated with the recipient's phone number, as described above in relation to FIGS. 2A and 2B. The transfer of funds between participating banks during settlement is using relies on the Outgoing Accumulated Accounts and Incoming Accumulated Accounts described above and is implemented by a separate application via the respective bank settlement and payment infrastructure 111, 122, 124 and/or 126. The implementation of a settlement system and/or application is within the ordinary skill of a person of skill in the art. The source and destination banks use the bank account information of the sender and recipient identified above in allocating the funds from the Outgoing Accumulated Accounts to the destination bank's Incoming Accumulated Account, and from the destination bank's Incoming Accumulated Account to the individual recipients.

For an immediate transfer, the destination bank will pay the recipient from an Immediacy Credit Fund Account before settlement occurs between the participating source and destination banks. It will be appreciated that each participating bank or other financial institution must maintain an Immediacy Credit Fund in configurations whether possibility of an immediate transfer is made available. During subsequent settlement between the source and destination bank, the source bank must reimburse the destination bank from the funds distributed to the recipient. This affects the accounts and timing by which funds are transferred from the sender's account to the source bank's outgoing settlement, and also affects the accounts and timing by which funds are transferred from the source bank's outgoing settlement to the destination bank's incoming settlement account. In particular, the destination bank's Immediacy Credit Fund Account is used to distribute funds to the recipient rather than the Incoming Accumulated Account used for a non-immediate transfer. The Immediacy Credit Account on the destination side is replenished during the normal settlement process from the destination Incoming Accumulated Account which receives the outstanding funds from the source Outgoing Accumulated Account.

It will be appreciated that the source and destination bank may be the same in some cases (i.e., where the sender and recipient have the same bank) in which cases the source and destination PayLink™ servers will be the same. It will be appreciated that each participating bank or other financial institution must maintain both and Incoming Accumulated Account and Outgoing Accumulated Account. In cases where the source and destination bank are the same, funds are transferred between the Incoming Accumulated Account and Outgoing Accumulated Account of the same bank.

Balance verification to ensure that sufficient funds exist in the sender's bank account is performed during approval of the transaction by the source bank during the transaction/call flow. Regardless of whether the funds transfer request is for an immediate or non-immediate transfer, if the funds are not available in the sender's bank account designated for the transfer then the transaction does not proceed and the sender will be notified accordingly during the transaction/call flow. From the sender's and recipient's perspective, the difference between an immediate or non-immediate transaction is the time required for the funds transfer to be completed by the source and destination financial institutions and the applicable service charges applied by the source and/or destination financial institutions.

The calculation and deduction of service charges/fees by the source and/or destination participating financial institutions has not been described, however the techniques for implementing this feature will be readily understood to a person of skill in the art. Depending on the system configuration and the options implemented by the participating financial institutions involved, service charges/fees may be deducted from one or both of the sender and recipient. In the case of the sender, the service charge may be deducted from the sender's account in addition to the transaction amount. In the case of the recipient, the service charge may be deducted from the amount to be deposited into the recipient's bank account. The service charges may appear as separate transactions or charges to the accounts of the sender and/or recipient, or may be deducted together with the transaction amount. Variations of these approaches will also be appreciated. The corresponding transactions by which the service fees are deducted from the sender and/or recipient and are transferred to source and destination financial institutions would be understood to a person of ordinary skill in the art.

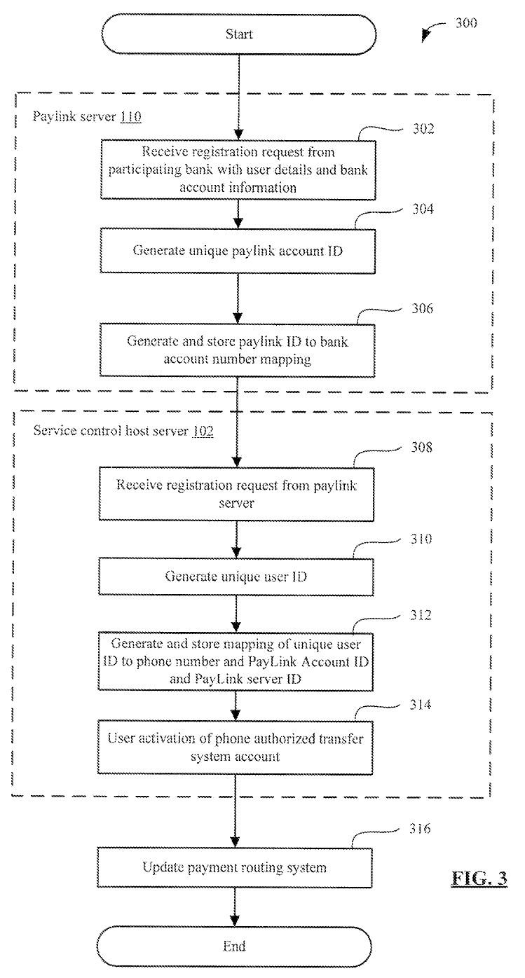

Referring to FIG. 3, operations 300 for registering a user of a participating institution (e.g. bank) and activating a user account in accordance with one embodiment of the present application will be described. In the first step 302, a registration request is received from the participating bank by a PayLink™ server 1110. The request includes user details and bank account information provided by the user's participating bank. Next, in step 304, a unique PayLink™ account ID is generated for the user.

In the next step 306, a mapping is generated between the bank account number and PayLink™ account ID, which is then stored in the PayLink™ database along with other account details (e.g. account type, currency).

The user may register multiple bank account numbers against the corresponding phone number. Each back account will have its own PayLink™ account ID which will be stored in the customer databases of the service control host server 102, 106 and PayLink™ server 110. The multiple PayLink™ account IDs are then mapped to the unique user id. This may be done using a Web-based account management user interface. Typically, the user the selects a preferred or default bank account to receive funds transfers. If the user has only one bank account, then this account is set as the preferred or default bank account. If the user has multiple bank accounts registered, the destination service control host server 106 selects the PayLink™ account ID of the recipient's preferred or default account to which to transfer funds. The preferred or default account may be changed by the user at any time using account/client management capabilities of the system 100. When initiating a funds transfer, depending on the configuration of the system 100, the sender may have the option to select from one of the registered bank accounts and need not be limited to using the preferred or default account.

Although bank account information is provided during steps 302 to 306, it will be appreciated by persons skilled in the art that the operations 300 have thus far occurred within the PayLink™ server 110 under the control of the source user's participating bank. No banking information is persisted outside of the bank server or its respective PayLink™ server 110. Depending on local regulatory requirements, bank account information may need to be first cleared by a government organization in which case banking information may be sent outside of the bank. In such cases, the banking information is transmitted securely and is only transitory and not persisted outside of the bank once the clearance has been given or denied. Clearance may be required in different circumstances, such as the anti-money laundering (AML) and terrorist financing reporting obligations on the part of financial institutions. For example in the United States, the OFAC (Office of Foreign Assets Control) is the regulatory body that administers and enforces economic and trade sanctions against targeted foreign countries and terrorists (e.g., prohibited transactions with persons named on the Specially Designated Nationals (SDN) List). Similarly, FinCEN (Financial Crimes Enforcement Network) administers federal money laundering regulations in the United States. In Canada, FINTRAC (Financial Transactions and Reports Analysis Centre) analyzes and discloses financial intelligence on suspected money laundering and terrorist financing. The Office of the Superintendent of Financial Institutions (OSFI) maintains a similar list to the SDN List.

In the next step 308, a registration request is sent from the PayLink™ server 110 to the service control host server 102. The request includes the PayLink™ account ID and other details supplied by the respective PayLink™ server 110, but does not include bank account information. Typically, the request includes a phone number currently managed by the respective service control host server, however one or more additional phone numbers can also be registered with the system 100 at this stage. Each phone number will be mapped to the same unique user ID once a user calls in to activate since accounts may be merged during activation.

In the next step 310, a unique user ID is generated for the source user. The unique user ID is at least unique within the service control host customer database 108. The unique user ID may be unique across service control host servers but this is not necessarily the case. Next, in step 312, a mapping of the unique user ID to phone number and PayLink™ account ID is generated and stored in the respective service control host customer database 108.

In the next step 314, the user activates the user account by calling into the system 100 (e.g., by calling a local or toll-free bank PAT number) from the registered phone number. The user is then prompted to enter a temporary or personal user identifier, such as a personal identification number (PIN), previously supplied, for example when the respective bank account was created. It will be appreciated that the personal user identifier is not limited to a string of alphanumeric characters in a PIN or password, but may be any user identifier mechanism. The telephone number and temporary PIN are then authenticated by the service control host server 102 (i.e. to check if an incoming phone number is the registered phone number and the temporary PIN is correct). If the temporary PIN and phone number are authenticated (i.e. PIN is correct and incoming phone number is the registered phone number), the PAT account is activated. Upon activation, the user is typically prompted to change the temporary PIN. If the PIN matches but the phone number associated with the incoming call is not the registered phone number, the PAT account is not activated and the user is instructed to contact the bank. If the PIN is incorrect, the PAT account is not activated. If the PIN is entered incorrectly more than a predetermined number of times (e.g. twice), the user is instructed to contact the bank.

In the next step 316, after activation of the user account, the payment routing system 104 is updated with the registered phone number. The payment routing system 104 generates a phone number and country code to service control host server address mapping that is stored in a corresponding database 103. It will be appreciated that no PayLink™ account ID or bank account information is supplied to or retained by the payment routing system 104.

Referring to FIG. 4, exemplary operations 400 or “call flow” for generating instructions for a funds transfer from the perspective of a user of the system 100 in accordance with one embodiment of the application will be described. The operations 400 assume the user has previously registered and activated his or her user account. In a first step 401, a source user wishing to make a funds transfer calls into the system 100 from a registered phone number, for example by dialling a local or toll-free bank PAT number. Typically, the system 100 implements an interactive voice response (IVR) application for handling user call flow is used as a typical user interface. IVR allows a user to interact with the system 100 using voice prompts responsive to user input on the keypad of a touch-tone wired or wireless phone. Typically, caller identification techniques are used to determine the sender's phone number.

In the next step 402, the user is prompted to enter a password or personal identification number (PIN) to verify the identity of the registered user. Typically, if the PIN entered is incorrect, the user is prompted to re-enter the PIN. If the PIN is entered incorrectly more than a predetermined number of times, access to the system 100 may be denied, the user instructed to contact his or her bank, and the call terminated. If the user attempts to call back, the user is again instructed to contact his or her bank and the call is terminated. In one embodiment, the step 402 is carried out by the service control host server 102 communicating with the appropriate source service control host server 102 and the source account information is also verified. This step may be omitted depending on the system configuration, for example, if the caller was already identified using caller identification techniques. Alternatively, a different authentication mechanism may be used in place of caller identification techniques, for example, if the caller's phone number is blocked or unlisted.

In the next step 404, the user is prompted to enter the destination country code of the recipient, for example “44” for the United Kingdom. In other embodiments, there may be no country code prompt because the system is adapted for use within the user's home or “source” country only. In other embodiments, there may be a preliminary prompt for the user to indicate whether the transaction is a domestic or international transaction, the result of which determines whether a country code prompt follows (i.e. if it is an international transaction). In yet another embodiment, the user would enter the complete International Dialling Prefix, destination country code and the phone number, and the system 100 would automatically determine whether the recipient is domestic or international.

In the next step 406, the user is prompted to enter the destination phone number of the recipient. In other embodiments, the user may be prompted to enter the country code after the destination phone number, for example after being prompted to specify if the recipient is in a different country than the source user. The user could also be prompted to enter an area or city code in addition to or as a part of the destination phone number (e.g. combined area/city code+local phone number).

In the next step 408, a confirmatory message is announced which confirms the country name and phone number of the recipient. The user is then prompted to confirm the country code and phone number, for example by pressing 1 on the telephone keypad to confirm or pressing 2 on the telephone keypad to reject. If the country code and phone number are rejected, operations loop back to step 404 where the user is requested to enter the country code. Operations continue until the user confirms the country name and phone number, or the call is terminated.

In the next step 410, the validity of the country code and phone number are checked. The validity check ensures that the country code and phone number are valid numbers and are registered with the system 100. If the country code and phone number are not valid or the phone number is not registered with the system 100, a corresponding error message will be played. The user will then be given the opportunity to enter another country code and phone number, at which time operations loop back to step 404, or end the call. Preferably, the validation step occurs after confirmation of the country code and phone number to avoid taking any further steps in the process if the input is invalid, however this step may occur later in the call flow if desired.

The next step 412 involves the source service control host server 102 contacting the payment routing system 104 to receive contact information for the appropriate destination service control host server 106. Once the source service control host server 102 is able to contact the destination service control host server 106, the user is prompted to select the source bank account from which the funds will be transferred. This step only occurs if the user has more than one bank account registered with the system 100. The bank accounts registered with the system 100 will be announced to the user indicating the type of bank account (checking, savings, etc.) and the user will be prompted to select the bank account from which to transfer the funds, for example by pressing a corresponding number on the telephone keypad.

In the next step 414, the user is prompted to select the currency of the funds transfer, for example Canadian dollar or U.K. pound, by pressing a corresponding number on the telephone keypad. The sender can select either the source account currency or the destination account currency to specify the transfer amount. The currency of the destination bank account may be obtained by the system 100 during the validation check in step 410, however no banking information is persisted outside of the bank server or its respective PayLink™ server 110 as discussed above. It will be appreciated that the currency of a bank account may be different that the currency of the country of origin of the account. For example, a U.K.-based source bank account could be a United States Dollar (USD) account.

In the next step 416, the user is prompted to enter the amount of the transfer in the selected currency. The steps 412, 414, and 416 generally involve the source service control host server 102 providing the destination service control host server 106 with the details of the transaction.

In the next step 417, the user is prompted to select the type of transaction. Typically, the user is given a choice between an immediate or non-immediate transfer. In the case of an immediate transfer, the destination bank will pay the recipient from an Immediacy Credit Fund Account before settlement occurs between the participating source and destination banks. In a non-immediate transfer, the settlement is equivalent to a conventional wire transfer and settlement will occur via the Outgoing Accumulated Account and Incoming Accumulated Account of the respective source and destination banks as described above. The choice will also affect the service fee calculated.

In the next step 418, a confirmatory message is played to the user in which the amount of the funds transfer and the currency are announced to the user, and optionally the exchange rate and amount in the foreign currency, where applicable (i.e., the amount in U.K. pounds and the applied exchange rate of the Canadian dollar to U.K. pound). Optionally, the user may be prompted to confirm the amount of the transfer, for example by pressing 1 on the telephone keypad to confirm or 2 to reject/cancel. If the amount is cancelled, operations loop back to step 414 where the user is requested to enter the currency of the funds transfer. Operations continue until the user confirms the amount of the funds transfer or the call is terminated. At this stage, the source service control host server 102 verifies the details of the transfer with the source PayLink™ server 110.

In the next step 420, the service fee for the transaction is announced to the user. In some configurations, the user may be given the option of selecting to pay the service fee or having the recipient pay the service fee, for example by pressing 1 to pay the service fee or 2 to have the recipient pay it.

In the next step 422, the user is prompted to confirm the funds transfer transaction. If the transaction is confirmed, operations proceed to step 424. The PayLink™ server 110 of the source bank then generates the funds transfer instructions as described above. If the transaction is cancelled, the call flow terminates without any transfer and the operations 400 end.

If the user has chosen to make a conventional transfer, the bank initiates a standard wire procedure and money is deposited into the destination user's account in the time frame required for a conventional wire transfer. If the user chose to make an immediate money transfer, the money is deposited immediately into the destination user's account from the Immediacy Credit Fund Account for the system 100 at the destination bank as described above. In the case of an immediate transaction, the destination bank will pay the recipient from the Immediacy Credit Fund Account before settlement occurs between the participating source and destination banks.

In the next step 424, a confirmatory message is played to the user in which the transaction is confirmed and a transaction confirmation number is announced to the user, typically a 9-digit number, which the user can use to track or confirm the funds transfer transaction with his or her participating bank and the recipient's bank.

Optionally, in the next step 426, the source user (transferor) and the recipient (transferee) are sent a confirmatory message by email or SMS (short message service), as the case may be, confirming the transaction and including the transaction confirmation number. The confirmatory message for the transferor and the transferee may not be the same. For example, for the transferor the confirmatory message may include the service charge where the transferor paid the fee, however this information may be omitted from the transferee's confirmatory message.

Although not shown, it will be appreciated by persons ordinarily skilled in the art that there are various checks performed at each step to ensure the user has entered a valid input. For example, if the user is given a choice between pressing 1 and 2 on the telephone keypad, checks are implemented and enforced to ensure that either 1 or 2 is entered by the user in order to maintain the call flow. Typically, if an invalid input is received, the user will be prompted to re-enter his or her selection at the respective step until a valid input is obtained or until a preset number of attempts are made.

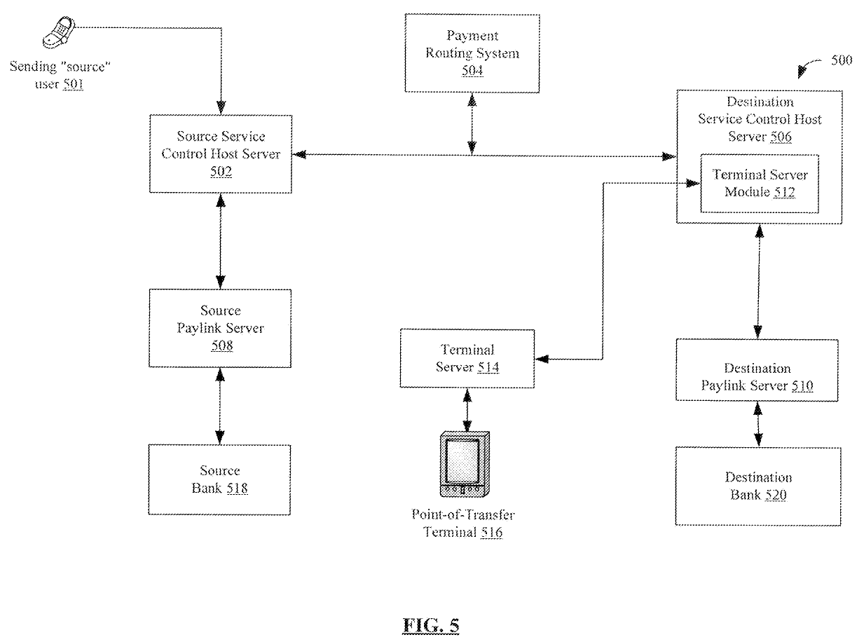

Referring now to FIG. 5, a system for generating and acquiring instructions for a funds transfer in accordance with another embodiment of the present application will be described. The system 500 comprises a source service control host server 502, destination service control host server 506, and a payment routing system 504 interconnected by a communications network (not shown). The source service control host server 502 is operatively connected to a source PayLink™ server 508 which, in turn, is securely connected to a source bank 518 and its communications, settlement and transfer infrastructure (not shown).

The destination service control host server 506 is connected to a destination PayLink™ server 510 which, in turn, is securely connected to a destination bank 520 and its communications, settlement and transfer infrastructure (not shown). The destination service control host server 506 includes a terminal server module 512 which is operatively connected to a point-of-transfer terminal server 514. The terminal server module 514 is operatively connected to a plurality of point-of-transfer (POT) terminals or devices 516. Only one POT terminal 516 has been shown for purpose of simplicity. Additionally, for the purpose of simplicity, the various communications networks interconnecting the system components have not been shown, however such communications networks would be appreciated and readily understood by a person of ordinary skill in the art. The system 500 is similar in many ways to the system 100 described above, but differs in that the destination service control host server 506 is coupled to POT terminals 516.

The POT terminal 516 provides a secure terminal for use by a recipient. The POT terminal 516 may include wireless fidelity (Wi-Fi) capabilities such as General Packet Radio Service (GPRS) connecting the POT terminal 516 to an Internet Protocol (IP) network. Alternatively, the POT terminal 516 may have a wired connection. The POT terminal 516 preferably also includes a printer, a keypad or pin-pad, and security components such as Europay-Mastercard-Visa (EMV) level 1 and 2 device components (e.g. magnetic stripe and chip card EMV readers).

The POT terminal 516 is provided with a phone authorized transfer and/or payment (PAT) application providing an interface for using the system 500 and having various security modules, for example in accordance with EMV or other security standard. The PAT application and security modules are typically pre-loaded during the manufacture of the POT terminal 516. The POT terminal 516 is preferably also provided with a remote control application or tool for updating the PAT application and its security modules, etc. The POT terminal 516 is also configured for secure software updates (downloads), and is preferably tamper resistant and tamper evident so as to provide an indication to the user if the POT terminal 516 has been tampered with.

In the wireless configuration, the POT terminal 516 is preferably connected through an IP network (e.g. GPRS) for fast transfer speeds. In addition, connecting the POT terminal 516 to an IP address allows for remote control and/or maintenance of the terminal PAT application.

The point-of-transfer capabilities of the system 500 provide a low unit cost implementation allowing for a more extensive coverage network (possible access points including hotels, gas stations, phone shops, supermarkets, DVD rental locations, pharmacies, post offices, public transit locations, airports, etc.), convenience and easy-to-use operation, an option for immediate payment, and an access point for consumers who have or who are not registered with a PAT system (i.e., because the consumer's bank is not a participating bank or the user has not registered).

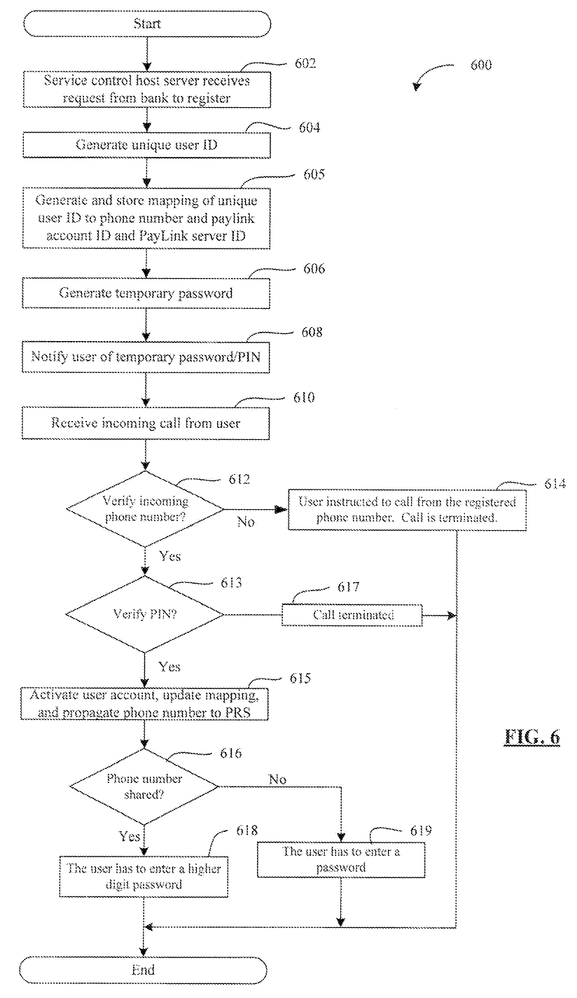

Referring now to FIG. 6, exemplary operations 600 for registering and activating a user account with a shared phone number in accordance with one embodiment of the present application will be described. In the first step 602, a service control host server 102 receives a request from the PayLink™ server 110 of a participating bank to register a user. The request includes the PayLink™ account ID and other information supplied by the respective PayLink™ server 110 but does not include bank account information. Typically, the request includes a phone number currently managed by the respective service control host server, however a new phone number can also be assigned to the user at this stage. The request may include country specific unique identification (ID) information that will be unique amongst all persons in a specific country, for example an identity card number such as a Social Insurance Number (SIN) or Social Security Number, etc. The unique identifier should be issued by a trusted authority such as a government body, unique within the country of origin, and universal to all peoples of that country.

In the next step 604, a unique user ID is generated for the source user. The unique user ID is at least unique within the service control host customer database 108. Next, in step 605, a mapping of the unique user ID to phone number and PayLink™ account ID is generated and stored in the respective service control host. The phone number is now registered but the user account has not been activated. Hence, the mapping of the phone number and customer account is stored in the service control host customer database 108, but is not yet active until the user calls in to activate and then the phone number is uploaded to the Payment Routing System 104.

In the next step 606, a temporary password or PIN is generated for the user. Typically, the temporary password is four digits. Next, in step 608, the user is notified of the temporary password. Preferably, the temporary password is provided by a secure channel such as registered mail or a secure electronic communication.

In the next step 610, the user calls into the system 100 from the registered phone number, for example by dialling a local or toll-free bank PAT number. Typically, the system implements an interactive voice response (IVR) application for handling user call flow that prompts the user for various inputs based on announced selections.

In the next step 612, the incoming phone number is verified by the service control host server. The incoming phone number is first determined via user caller identification techniques. The determined phone number is then compared against registered phone numbers in the service control host. If the determined phone number matches one of these phone numbers, operations proceed to step 613. If the determined phone number does not match one of these phone numbers, operations proceed to step 614 where the user is instructed to call from the registered phone number and the call is terminated.

In the next step 613, the user is prompted to enter the temporary password which is then verified by the service control host server. Optionally, the user may be requested to enter the identify card number (e.g. SIN) or other country specific unique ID provided by the user and transmitted by the PayLink™ server to the user's respective service control host server. If the PIN and optional country specific ID are verified, operations proceed to step 615 where PAT account is activated and the mapping of the unique user ID to phone number to PayLink™ account ID is updated in the customer database 108 of respective service control host server. If the PIN and/or optional country specific ID are entered incorrectly more than a predetermined number of times (e.g. twice), operations proceed to step 617 where the user is instructed to contact the bank and the call is terminated. Typically, upon activation, the user is prompted to change the temporary PIN.

In the next step 616, the phone number is checked to determine if the phone number is shared with one or more other users. To determine if the phone number is shared, a check or lookup is performed on the customer database 108 to determine if the phone number is present in the customer database 108. If the phone number is present in the customer database 108, the phone number is already associated with an active user account and so is shared. If the phone number is not present in the customer database 108, the phone number is not already associated with an active user account and so is not shared. Of course each user account (and therefore phone number) will be removed from the customer database 108 if their account is cancelled.

It should be appreciated that the system configuration is such that a user account (and therefore the user's registered phone number) will not be stored/present in the payment routing system database 103 until the account is activated. Once the account is activated, the phone number is uploaded to the Payment Routing System 104 (e.g., stored in the database 103). It is possible that a first user's phone number may be registered with the system 100 (i.e., stored in the customer database 108 in the service control host), but that the first user has not activated his or her user account. In this case, the phone number will not appear in the customer database 103 in the payment routing system. If a second user were to attempt to register and activate their user account in association with the same phone number at this time, the system would not show the phone number in the customer database as active and so the phone number would be unshared when the second user attempts to register and activate their account. Following activation of the second user's account, when the first user attempts to activate their user account, the phone number would already be associated with the second user's account and so the phone number would appear to be shared to the first user.

If the phone number is not shared, operations 600 proceed to step 619 where the user is required to change the temporary password. Typically, the password is the same length as the temporary password, for example a four-digit password.

If the phone number is shared, operations 600 proceed to step 618 where the user is required to change the temporary password to a longer or higher-digit password than the password of the first or previously registered user. For example, a second registered user may be required to enter a five-digit password where the first registered user has a four-digit password. If additional users register, each will be required to enter a higher password having additional digits for extra security (e.g. 6, 7 and 8 digits for third, fourth and fifth registered users). In this way, each user account on a shared phone number has a different password, and preferably a different length password providing additional security.

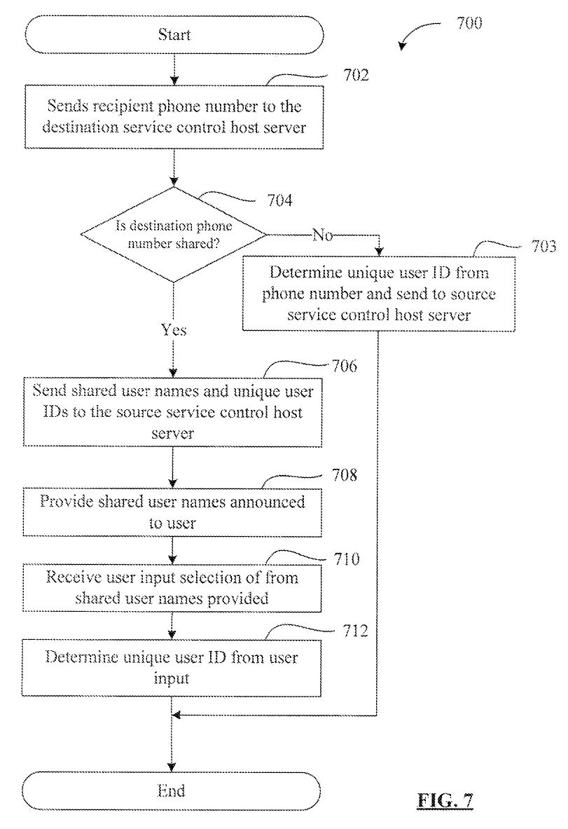

Referring now to FIG. 7, exemplary operations 700 for identifying recipients on a shared phone number in accordance with one embodiment of the present application will be described. In the first step 702, the source service control host server 102 transmits the recipient or “destination” phone number to the respective destination service control host server 106. The destination service control host server 106 is determined by the payment routing system 104 using its phone number to service control host server address mappings.

In the next step 704, the destination service control host server 106 determines if the recipient phone number is shared. If the destination phone number is associated with more than one unique user ID in its customer database 108, the destination phone number is shared. If the destination phone number is associated with only one unique user ID in its customer database 108, then the destination phone number is not shared.

If the destination phone number is not shared, operations 700 proceed to step 703 where the destination service control host server determines the unique user ID from the destination phone number using its phone number to unique user ID mappings. The unique user ID is then sent from the destination service control host server 106 to the source service control host server 102. If the destination phone number is shared, operations 700 proceed to step 706, where the shared recipient user names and respective unique user IDs are sent to the source service control host server 102.

In the next step 708 the shared user names are announced to the source user using a text-to-speech application of the interactive voice response (IVR) application. Next, in step 710, the user is prompted to select the recipient from the shared recipient user names announced, for example by pressing a number of the telephone keypad corresponding to the intended recipient (e.g. 1 for “Heather Barron”, 2 for “Peter Makkai”, etc.).

In the next step 712, the source service control host server 102 determines the unique user ID of the recipient based on the user input, i.e. the number input is correlated to the shared recipient and to the respective unique user ID transmitted by the destination service control host server 106.

After the source service control host server 102 has determined the unique user ID of the recipient, either by steps 706-712 where the destination phone number is shared or step 703 where the destination phone number is not shared, the unique user ID can be transferred to the source PayLink™ server 110. The source PayLink™ server 110 can then include the unique user ID of the recipient when it generates funds transfer instructions. Depending on the settlement process implemented, in some embodiments the funds transfer instructions are typically instructions sent to the recipient's bank via the destination service control host server 106 and destination PayLink™ server to transfer funds from the destination bank's Incoming Accumulated Account or the Immediacy Credit Account to the recipient's bank account using the recipient's unique user ID and an identifier. The PayLink™ account ID and bank account information can be determined by the destination service control host server 106 and destination PayLink™ server as described above. If the user has multiple bank accounts registered, the destination service control host server 106 selects the PayLink™ account ID of the recipient's preferred or default account, as described above.

The phone authorized transfer and/or payment method and system described in the present application allows for the generation and authorization of funds transfer instructions between registered users in a manner that limits the access and processing of personal information. The sender requires only the recipient's phone number as reference to the recipient's bank account. Phone numbers are not generally considered security sensitive and can frequently be obtained from publicly accessible directories. Such directories also provide the sender with an alternate means of determining the phone number of a registered recipient.

The method and system of the present application provides a distributed solution in which the respective service control host server do not have access to bank account information of their customers, and the respective banks and other participating institutions do not have access to telephone service information. An identifying proxy is used during a transaction to identify the sender and recipient. In some embodiments, the system allows funds transfer instructions to be generated and authorized using a network of point-of-transfer terminals. In this way, funds transfer instructions can be generated and authorized for recipients that are registered with the system 100.

The method and system described in the present application combine the availability and user-friendly nature of telephones with security processes to enable funds transfers using existing banking communications infrastructures. The method and system may be adapted for wired (landline) or wireless phones and communications devices, for any language, and for any telecommunication service provider's communication network.

For banks and other participating institutions, the method and system described in the present application may provide an additional revenue source, shift customers to electronic funds transfers allowing a reduction in check fraud and accommodate consumer demands for automated online services, reduce labour costs in the bank branch network, reduce central (“wire room”) error processing, and combine funds transfer transaction and foreign exchange revenue.

For end-users, the method and system described in the present application may provide faster, more convenient and enhanced security. The method and system may also provide lower transfer costs than alternative transfer methods. In addition, the system also provides an immediate funds transfer capability, for example by immediately crediting a recipient account from the Immediacy Credit Fund Account described above, the transferred funds to be later recovered. Further, certain vendors require cleared funds before proceeding with transactions. With the phone authorized transfer and/or payment system cleared funds are immediately available. A recipient can receive confirmation (e.g. in the case of immediacy) that the participating institution (e.g. bank) has confirmed receipt of instructions to transfer funds, and confirmation that the funds are available to the recipient account via the Immediacy Credit Fund Account.

The phone authorized transfer and/or payment method and system described in the present application may be used by many types of participating financial institutions, e.g. banks (foreign and domestic), credit unions, trust companies, and other participating organizations (e.g. corporations, charities, discount brokerages, post offices, tourism centres and currency exchanges), and POT locations (e.g. Western Union™).

In accordance with other embodiments, rather than using an IVR application to interface with a user, a computer-implemented user interface such as a Web-based user interface may be used to perform the methods embodied by the operations 200, 250, 400, 600 and/or 700. At least the methods embodied by the operations 200, 250 and 400 could be implemented by an SMS-based user interface. To generate instructions for a funds transfer, the sender and recipient must be registered with the system and have active user accounts as with the IVR-based user interface described above. In such embodiments, the sender's phone number does not to be provided to identify the sender. Instead of the sender's phone number, another identifier or other form of identification technique may be used to identify the sender with confidence. The particular method of identification may vary between different embodiments.

In the context of a Web-based user interface, the user may securely log into the PAT system, for example, using an online banking user interface of the sender's bank using a user ID and password, etc. Once logged into a secure online banking application, the user may then securely access a PAT application. The PAT application may be securely connected to the online banking application or integrally formed as a part of the online banking application. Using onscreen displays and prompts the PAT application then obtains the recipient's phone number and the other transaction information from the sender following a transaction flow similar to the operations 200 and 250 described above in connection with FIGS. 2A and 2B.

Alternatively, the computer-implemented user interface may be some other type of online user interface accessible from a desktop computer or wireless communications device such as a wireless-enabled personal data assistant (PDA) or wireless phone. For example, the PAT application may be provided as a value-added service on a wireless communication device. Once the user has securely logged in to the PAT application or system, or once the user's identity has been verified on the computing device or wireless communication device, the user may then proceed with the process of entering the recipient's phone number and the other transaction information via onscreen prompts.

Although the term “source” is sometimes used in the present application to describe the originating or sending user (i.e. the transferor) in a transaction and the corresponding system components (e.g. service control host and PayLink™ servers), and that the terms recipient and destination have been used to describe the recipient user (i.e. the transferee) in a transaction along with the corresponding system components, it will be appreciated that these transactional references have been used for the purpose of convenience in the illustrative embodiments and that such terms are not intended to limit the claims or the various system components in any way. Further, it will be appreciated that a user and his respective system components may be a sender (source) in one transaction and a recipient (destination) in another transaction. In addition, although the transactions are sometimes described as funds transfers, the present application is equally applicable to payment transactions, e.g. bill payments. Accordingly, the present application describes phone authorized payment methods and systems as well as phone authorized transfer methods and systems.

In accordance with another embodiment of the application, there is provided a method for identifying a recipient from multiple registered users on a shared phone number in a phone authorized transfer and/or payment system, the method comprising the steps of: determining if the recipient's phone number is associated with more than one unique user ID; if the recipient's phone number is associated with more than one unique user ID, providing a list of shared user names to the sender; receiving an input from the sender selecting the recipient from the list of shared user names; and determining the second unique user ID from the mapping of unique user IDs to phone in accordance with the input from the caller.

In some embodiments, if the recipient's phone number is not associated with more than one unique user ID, determining the second unique user ID corresponding to the recipient's phone number from a mapping of unique user IDs to phone numbers in the first or second customer database without providing a list of shared user names or requesting an input from the caller.

In accordance with another embodiment of the application, there is provided a system for identifying a recipient from multiple registered users on a shared phone number in a phone authorized transfer and/or payment system, the system comprising: a telephone gateway application server for managing the user's funds transfer communications, the telephone gateway application server being operatively connected to a customer database, the telephone gateway application comprising a processor operatively connected to a memory, the memory having data and instructions stored thereon to configure the telephone gateway application server to: determine if the recipient's phone number is associated with more than one unique user ID in the first or second customer database; if the recipient's phone number is associated with more than one unique user ID in the first or second customer database, provide a list of shared user names to the caller; receive an input from the caller selecting the recipient from the list of shared user names; and determine the second unique user ID from the mapping of unique user IDs to phone numbers in the first or second customer database in accordance with the input from the caller.

In some embodiments, the telephone application gateway server is further configured to associate the input from the caller selecting the recipient from the list of shared user names with the respective second unique user ID. In some embodiments, the telephone application gateway server is further configured to: if the recipient's phone number is not associated with more than one unique user ID, determine the second unique user ID corresponding to the recipient's phone number from a mapping of unique user IDs to phone numbers in the first or second customer database without providing a list of shared user names or requesting an input from the caller.

While the operations 200, 250, 400, 600 and 700 are described as being performed sequentially, it will be understood by those skilled in the art that the methods embodied by these operations need not necessarily be executed in the shown order, and that variations in the method order may be implemented as would be understood to a person skilled in the art.

While aspects of this application are primarily discussed as a method, persons of ordinary skill in the art would understand that the systems described above may be programmed and configured to enable the methods of the application to be practised. Moreover, articles of manufacture for use with the systems, such as a pre-recorded storage device or other machine or computer readable medium including program instructions recorded thereon may direct the systems to facilitate the practise of the methods of the application. It is understood that such systems and articles of manufacture also come within the scope of the application.

The embodiments of the present disclosure described above are intended to be examples only. Those of skill in the art may effect alterations, modifications and variations to the particular embodiments without departing from the scope of the present disclosure. In particular, selected features from one or more of the above-described embodiments may be combined to create alternative embodiments not explicitly described, features suitable for such combinations being readily apparent to persons skilled in the art. The subject matter described herein in the recited claims intends to cover and embrace all suitable changes in technology.

1. A phone authorized transfer and/or payment system for generating funds transfer instructions between a sender and a recipient, each of the sender and recipient having a phone number registered with the system and stored within a respective customer database, the system comprising:
a first telephone application gateway server comprising a processor operatively connected to a memory, the memory having data and instructions stored thereon to configure the first telephone application gateway server to implement an interactive voice response (IVR) application for interfacing with a sender and to:
request and receive a funds transfer request from the sender via a call received by the IVR application, the funds transfer request comprising at least an amount for transfer (the “transaction amount”) and a phone number of the recipient;
determine the sender's phone number;
verify the determined sender's phone number against registered phone numbers in a first customer database connected to the first telephone application gateway server; and
if the determined sender's phone number is verified,
determine a first proxy identifier (ID) associated with at least the determined sender's phone number from the first customer database; and
send to a first transaction instruction server managed by a first participating institution a first funds transfer request to transfer funds from an account of the sender at the first participating institution to an outgoing settlement account of the first participating institution, wherein the first funds transfer request includes the first proxy ID as a pointer to the account of the sender from which the funds are to be transferred, the first funds transfer request instructing the first transaction instruction server to generate a first funds transfer instruction.

2. The system of claim 1, wherein the determining of the first proxy ID comprises:
determining a first unique user identifier (ID) corresponding to the sender's phone number from a mapping of unique user IDs to phone numbers in the first customer database; and
determining the first proxy ID from the first unique user ID from a mapping of unique user IDs to first proxy IDs in the first customer database.

3. The system of claim 1, wherein the first telephone application gateway server is further configured to:
if the determined sender's phone number is not verified, terminate the call.

4. The system of claim 1, wherein the first telephone application gateway server is further configured to:
determine a second proxy identifier (ID) associated with the phone number of the recipient received by the IVR application; and
request the first transaction instruction server to send to a second transaction instruction server managed by a second participating institution a second funds transfer request to transfer funds to an account of the recipient at the second participating institution from an incoming settlement account of the second participating institution, wherein the second funds transfer request includes the second proxy ID as a pointer to the account of the recipient to which the funds are to be transferred, the second funds transfer request instructing the second transaction instruction server to generate a second funds transfer instruction.

5. The system of claim 4, wherein the determining of the second proxy ID comprises:
determining a second unique user identifier (ID) corresponding to the recipient's phone number from a mapping of unique user IDs to phone numbers in the first customer database if recipient's phone number is stored within the first customer database, or a second customer database associated with and connected to another telephone application gateway server if recipient's phone number is not stored within the first customer database; and
determining the second proxy ID from the second unique user ID from a mapping of unique user IDs to second proxy IDs in the first or second customer database.

6. The system of claim 5, wherein the first telephone application gateway server is further configured to:
identify the first and second transaction instruction servers using addressing information associated with the first and second proxy IDs stored in the respective customer databases.

7. The system of claim 5, wherein the mapping of unique user IDs to phone numbers and the mapping of unique user IDs to proxy IDs are provided by a common mapping in the respective customer databases.

8. The system of claim 7, wherein the first and second customer databases each comprise mappings of phone numbers to unique user ID to proxy IDs for registered users.

9. The system of claim 8, wherein the first and second customer databases further comprise a mapping of proxy IDs to an address of the associated transaction instruction server.

10. The system of claim 5, further comprising:
the first transaction instruction server, the first transaction instruction server comprising a processor operatively connected to a memory, the memory having data and instructions stored thereon to configure the first transaction instruction server to:
receive the first funds transfer request from the telephone application gateway server;
determine an account number of the sender from the first proxy ID in the first funds transfer request using a mapping of proxy IDs to account numbers in a database associated with the first transaction instruction server;
generate the first funds transfer instruction to transfer an amount from the account number of the sender to the outgoing settlement account of the first participating instruction; and
post the first funds transfer instruction to a first electronic settlement system of the first participating institution.

11. The system of claim 10, further comprising:
the second transaction instruction server, the second transaction instruction server comprising a processor operatively connected to a memory, the memory having data and instructions stored thereon to configure the second transaction instruction server to:
receive the second funds transfer request from the first transaction instruction server;
determine an account number of the sender from the second proxy ID in the second transfer request using a mapping of proxy IDs to account numbers in a database associated with the first or second transaction instruction server;
generate the second funds transfer instruction to transfer an amount to the account number of the recipient from the incoming settlement account of the second participating instruction; and
post the second funds transfer instruction to a second electronic settlement system of the second participating institution.

12. The system of claim 11, further comprising:
a first electronic settlement system of the first participating instruction, a second electronic settlement system of the second participating instruction, and a communications network connecting the first electronic settlement system and second electronic settlement system;
the first electronic settlement system being configured to transfer funds from the account number of the sender to the outgoing settlement account of the first participating institution in accordance with posted first funds transfer instruction;
the second electronic settlement system being configured to transfer funds to the account number of the recipient from the incoming settlement account of the second participating institution in accordance with posted second funds transfer instructions;
the first and second electronic settlement systems being configured to transfer funds between the outgoing settlement account and the incoming settlement account of each of the first and second participating institutions.

13. The system of claim 4, wherein the first and second participating institutions are the same or different, the first and second transaction instruction servers of the first and second participating institutions being the same or different, respectively.

14. The system of claim 1, wherein the IVR application implemented by the first telephone application gateway server is further configured to request and receive from the sender a currency for transfer if the currency of the sender's account and recipient account are different.

15. The system of claim 1, wherein the IVR application implemented by the first telephone application gateway server is further configured to request and receive from the sender a personal user identifier, and wherein the first telephone application gateway server is further configured to:
verify if the personal user identifier received by the IVR application matches a personal user identifier stored in the first customer database; and
if the personal user identifier matches, determine the first proxy ID.

16. The system of claim 15, wherein the first telephone application gateway server is further configured to:
if the personal user identifier does not match, repeat the requesting and receiving of the personal user identifier until the personal user identifier matches or until a pre-determined number of failures to match has occurred.

17. The system of claim 15, wherein the first unique user ID is determined using the determined phone number and the verified personal user identifier using a mapping of unique user IDs to phone numbers and personal user identifiers.

18. The system of claim 4, further comprising:
a plurality of telephone application gateway servers; and
a routing system connected to the first telephone application gateway server and the plurality of telephone application gateway servers, the routing system comprising a central repository containing mappings of phone numbers to respective telephone application gateway server addresses for all users registered with the system;
wherein the first telephone application gateway server is further configured to: if the recipient's phone number is not stored within the first customer database, request from the routing system the address of the telephone application gateway server associated with the recipient's phone number; and
wherein the routing system is configured to provide the address of the telephone application gateway server associated with the recipient's phone number in response to a request from the first telephone application gateway server.

19. The system of claim 18, wherein the first telephone application gateway server is further configured to: if the recipient's phone number is not stored within the first customer database, request from the telephone application gateway server associated with the recipient's phone number the second proxy ID associated with the recipient's phone number.

20. The system of claim 18, wherein the central repository is a global repository containing mappings of domestic and international phone numbers to the respective telephone application gateway server addresses.

21. The system of claim 5, wherein the first telephone application gateway server is further configured to:
determine if the recipient's phone number is associated with more than one unique user ID in the first or second customer database;
if the recipient's phone number is associated with more than one unique user ID in the first or second customer database, provide a list of shared user names to the sender;
receive an input from the sender selecting the recipient from the list of shared user names; and
determine the second unique user ID from the mapping of unique user IDs to phone numbers in the first or second customer database in accordance with the input from the sender.

22. The system of claim 21, wherein the first telephone application gateway server is further configured to associate the input from the sender selecting the recipient from the list of shared user names with the respective second unique user ID.

23. The system of claim 21, wherein the first telephone application gateway server is further configured to: if the recipient's phone number is not associated with more than one unique user ID, determine the second unique user ID corresponding to the recipient's phone number from a mapping of unique user IDs to phone numbers in the first or second customer database without providing a list of shared user names or requesting an input from the sender.

24. A method for generating funds transfer instructions between a sender and a recipient in a phone authorized transfer and/or payment system, each of the sender and recipient having a phone number registered with the system and stored within a respective customer database, the method comprising the steps of:
receiving an identifier associated with the sender;
receiving from the sender a funds transfer request on a first server, the funds transfer request comprising at least an amount for transfer (the “transaction amount”) and a phone number as identifying information of a recipient to which the funds are to be transferred;
determining a first proxy identifier (ID) associated with the identifier of the sender;
sending to a first transaction instruction server instructions to generate funds transfer instructions associated with the first proxy ID; and
generating first funds transfer instructions on the first transaction instruction server, the first funds transfer instructions including the first proxy ID as a pointer to an account of the sender at a first participating institution from which the funds are to be transferred.

25. The method of claim 24, further comprising, after the step of receiving the funds transfer request, the step of:
determining a first unique user identifier (ID) corresponding to the identifier of the sender, wherein the step of determining the first proxy ID comprises determining the first proxy ID from a mapping of unique user IDs to proxy IDs.

26. The method of claim 25, wherein the first unique user ID is determined from the phone number of the sender and a personal user identifier provided with the funds transfer request.

27. The method of claim 24, further comprising the step of determining an address of the first transaction instruction server from a mapping of proxy IDs to server addresses.

28. The method of claim 24, wherein the step of generating the first funds transfer instructions comprises: generating first funds transfer instructions to transfer funds from the account of the sender at the first participating to an outgoing settlement account of the first participating institution.

29. The method of claim 24, further comprising the steps of:
determining a second proxy identifier (ID) associated with the recipient's phone number;
sending to a second transaction instruction server instructions to generate second funds transfer instructions associated with the second proxy ID; and
generating second funds transfer instructions on the second transaction instruction server, the second funds transfer instructions including the second proxy ID as a pointer to an account of the recipient at a second participating institution to which the funds are to be transferred.

30. The method of claim 29, further comprising the step of:
determining a second unique user identifier (ID) corresponding to the recipient's phone number from a mapping of unique user IDs to registered phone numbers, wherein the step of determining the second proxy ID comprises determining the second proxy ID from a mapping of unique user IDs to second proxy IDs.

31. The method of claim 29, further comprising the step of determining an address of the second transaction instruction server from a mapping of proxy IDs to server addresses.

32. The method of claim 29, wherein the step of generating the second funds transfer instructions comprises: generating second funds transfer instructions to transfer funds to the account of the recipient at the second participating institution from an incoming settlement account of the second participating institution.

33. The method of claim 29, wherein the first and second participating institutions are the same or different, the first and second transaction instruction servers of the first and second participating institutions being the same or different, respectively.

34. The method of claim 24, wherein the identifier of the sender is a phone number of the sender registered with the system, the method further comprising the step of determining the phone number of the sender, the first unique user ID being determined from a mapping of unique user IDs to registered phone numbers.

35. The method of claim 24, wherein the method is implemented via a graphical user interface on a display of a computing device.

36. The method of claim 24, wherein the method is implemented by an interactive voice response (IVR) application of a telephone application gateway server.

37. The method of claim 29, further comprising the steps of:
determining if the recipient's phone number is associated with more than one unique user ID;
if the recipient's phone number is associated with more than one unique user ID, providing a list of shared user names to the sender;
receiving an input from the sender selecting the recipient from the list of shared user names; and
determining the second unique user ID from the mapping of unique user IDs to phone in accordance with the input from the caller.

38. The method of claim 37, further comprising the steps of:
if the recipient's phone number is not associated with more than one unique user ID, determining the second unique user ID corresponding to the recipient's phone number from a mapping of unique user IDs to phone numbers in the first or second customer database without providing a list of shared user names or requesting an input from the caller.

39. A system for generating funds transfer instructions between a sender and a recipient, each of the sender and recipient having a phone number registered with the system and stored within a respective customer database, the system comprising:
a first server having a processor operatively connected to a memory, the memory having data and instructions to configure the server to:
receive an identifier from a sender;
receive from the sender a funds transfer request, the funds transfer request comprising at least an amount for transfer (the “transaction amount”) and a phone number as identifying information of a recipient to which the funds are to be transferred;
determine a first proxy identifier (ID) associated with the identifier of the sender; and
send to a first transaction instruction server instructions to generate funds transfer instructions associated with the first proxy ID,
wherein the first transaction instruction server generates first funds transfer instructions, the first funds transfer instructions including the first proxy ID as a pointer to an account of the sender at a first participating institution from which the funds are to be transferred.

40. The system of claim 39, wherein the first server is configured to determine a first unique user identifier (ID) corresponding to the identifier of the sender, wherein the step of determining the first proxy ID comprises determining the first proxy ID from a mapping of unique user IDs to proxy IDs.

41. The system of claim 40, wherein the first server is configured to determine the first unique user ID from the phone number of the sender and a personal user identifier provided with the funds transfer request.

42. The system of claim 39, wherein the first server is further configured to determine an address of the first transaction instruction server from a mapping of proxy IDs to server addresses.

43. The system of claim 39, wherein the first transaction instruction server generating the first funds transfer instructions comprises: generating first funds transfer instructions to transfer funds from the account of the sender at the first participating to an outgoing settlement account of the first participating institution.

44. The system of claim 39, wherein the first server is further configured to:
determine a second proxy identifier (ID) associated with the recipient's phone number; and
send to a second transaction instruction server via the first transaction instruction server instructions to generate second funds transfer instructions associated with the second proxy ID,
wherein the second transaction instruction server generates second funds transfer instructions, the second funds transfer instructions including the second proxy ID as a pointer to an account of the recipient at a second participating institution to which the funds are to be transferred.

45. The system of claim 44, wherein the first server is further configured to determine a second unique user identifier (ID) corresponding to the recipient's phone number from a mapping of unique user IDs to registered phone numbers, wherein the step of determining the second proxy ID comprises determining the second proxy ID from a mapping of unique user IDs to second proxy IDs.

46. The system of claim 44, wherein the first server is further configured to determine an address of the second transaction instruction server from a mapping of proxy IDs to server addresses.

47. The system of claim 44, wherein the second transaction instruction server generating second funds transfer instructions comprises: generating second funds transfer instructions to transfer funds to the account of the recipient at the second participating institution from an incoming settlement account of the second participating institution.

48. The system of claim 44, further comprising:
the first transaction instruction server, the first transaction instruction server comprising a processor operatively connected to a memory, the memory having data and instructions stored thereon to configure the first transaction instruction server to:
receive the first funds transfer request from the first server;
determine an account number of the sender from the first proxy ID in the first funds transfer request using a mapping of proxy IDs to account numbers in a database associated with the first transaction instruction server;
generate the first funds transfer instruction to transfer an amount from the account number of the sender to the outgoing settlement account of the first participating institution; and
post the first funds transfer instruction to a first electronic settlement system of the first participating institution.

49. The system of claim 48, further comprising:
the second transaction instruction server, the second transaction instruction server comprising a processor operatively connected to a memory, the memory having data and instructions stored thereon to configure the second transaction instruction server to:
receive the second funds transfer request from the first transaction instruction server;
determine an account number of the recipient from the second proxy ID in the second transfer request using a mapping of proxy IDs to account numbers in a database associated with the second transaction instruction server;
generate the second funds transfer instruction to transfer an amount to the account number of the recipient from the incoming settlement account of the second participating institution; and
post the second funds transfer instruction to a second electronic settlement system of the second participating institution.

50. The system of claim 49, further comprising:
the first electronic settlement system of the first participating institution, the second electronic settlement system of the second participating institution, and a communications network connecting the first electronic settlement system and second electronic settlement system;
the first electronic settlement system being configured to transfer funds from the account number of the sender to the outgoing settlement account of the first participating institution in accordance with the posted first funds transfer instruction;
the second electronic settlement system being configured to transfer funds to the account number of the recipient from the incoming settlement account of the second participating institution in accordance with the posted second funds transfer instruction; and
the first and second electronic settlement system being configured to transfer funds between the outgoing settlement account and the incoming settlement account of each of the first and second participating institutions.

51. The system of claim 39, further comprising a user terminal for receiving input from the sender, the user terminal having a display having a graphical user interface (GUI) displayed thereon, wherein the user terminal is one of a wireless communication, personal computer or point-of-transfer (POT) terminal.

52. The system of claim 44, wherein the first and second participating institutions are the same or different, the first and second transaction instruction servers of the first and second participating institutions being the same or different, respectively.

53. The system of claim 39, wherein the identifier of the sender is a phone number of the sender registered with the system, the method further comprising the step of determining the phone number of the sender, the first unique user ID being determined from a mapping of unique user IDs to registered phone numbers.

54. A method for registering a user in a phone authorized transfer and/or payment system, the method comprising the steps of:
receiving a request to register the user on a telephone gateway application server for managing the user's funds transfer communications, the request including a phone number of the user and a proxy identifier (ID) to an account of the user at a first participating institution from which funds are to be transferred;
generating a unique user identifier (ID) being unique at least within a customer database connected to the telephone gateway application server;
storing a mapping of the phone number of the user to the unique user ID to the proxy ID in the customer database; and
receiving an activation request from the user.

55. The method of claim 54, further comprising, after receiving an activation request from the user:
determining if the phone number of the user is shared with one or more other users; and
if the phone number of the user is shared,
requesting and receiving a personal user identifier from the user,
comparing the personal user identifier received from the user with the personal user identifier of the one or more other users with whom the phone number is shared, and
if the personal user identifier received from the user is not different from the personal user identifier of the one or more other users with whom the phone number is shared, repeating the requesting and receiving of the personal user identifier until the personal user identifier is different from the personal user identifier of the one or more other users with whom the phone number is shared.

56. The method of claim 55, wherein the personal user identifier requested from the user has a different structure than the personal user identifier of the one or more other users with whom the phone number is shared.

57. The method of claim 55, wherein the step of determining if the user's phone number is shared comprises:
determining if an active user account is associated with the user's phone number in the customer database, wherein the user's phone number is shared if the user's phone number is associated with a user account in the customer database, and wherein the user's phone number is not shared if the user's phone number is not associated with a user account in the customer database.

58. The method of claim 54, wherein the activation request includes a temporary personal user identifier provided by the system.

59. The method of claim 58, further comprising, after the step of receiving an activation request:
identifying the phone number from which the activation request was sent using a caller identification process;
comparing the identified phone number with phone numbers of inactivated accounts in the customer database; and
if the identified phone number is a phone number of an inactivated account in the customer database,
comparing the temporary personal user identifier provided in the activation request with the temporary personal user identifier stored in the customer database,
if the temporary personal user identifier provided in the activation request matches, activating the account of the user and propagating the phone number and unique user ID to a routing component of the payment system, and
if the temporary personal user identifier provided in the activation request does not match, repeating the requesting and receiving of the personal user identifier until the personal user identifier matches or until a pre-determined number of failures to match has occurred.

60. The method of claim 59, further comprising, before the step of receiving an activation request and after the step of generating a unique user ID, the step of sending a notification message to the user including the temporary personal user identifier.

61. The method of claim 60, wherein the notification message is a secure communication.

62. The method of claim 54, wherein the activation request includes a country-specific unique identifier provided by the user, the method further comprising:
if the identified phone number is a phone number of an inactivated account in the customer database, before activating the account of the user,
comparing the country-specific unique identifier provided in the activation request with a country-specific unique identifier stored in the customer database,
if the country-specific unique identifier provided in the activation request matches, activating the account of the user, and
if the temporary personal user identifier provided in the activation request does not match, repeating requesting and receiving of the personal user identifier until the personal user identifier matches or until a pre-determined number of failures to match has occurred.

63. A system for registering a user having a shared phone number in a phone authorized transfer system, the system comprising:
a telephone gateway application server for managing the user's funds transfer communications, the telephone gateway application server being operatively connected to a customer database, the telephone gateway application server comprising a processor operatively connected to a memory, the memory having data and instructions stored thereon to configure the telephone gateway application server to:
receive a request to register the user, the request including a phone number of the user and a proxy identifier (ID) to an account of the user at a first participating institution from which funds are to be transferred;
generate a unique user identifier (ID) being unique at least within a customer database connected to the telephone gateway application server;
store a mapping of a phone number of the user to the unique user ID to the proxy ID in the customer database; and
receive an activation request from the user.
